(19) United States
(12) Patent Application Publication
(10) Pub. No.: US 2021/0009177 A1
(43) Pub. Date: Jan. 14, 2021

(54) MULTI-TIERED SLEEVE PACK ASSEMBLY

(71) Applicant: ORBIS Corporation, Oconomowoc, WI (US)

(72) Inventors: Scott J. Buss, Johnson Creek, WI (US); Benjamin J. Thompson, Watertown, WI (US)

(21) Appl. No.: 16/923,846

(22) Filed: Jul. 8, 2020

Related U.S. Application Data
(60) Provisional application No. 62/873,437, filed on Jul. 12, 2019.

(51) Int. Cl. B62B 3/00; B62B 3/16; B62B 3/02

(52) U.S. Cl. CPC B62B 3/002; B62B 3/02; B62B 3/005; B62B 3/16

(57) ABSTRACT

The invention is directed to a multi-tiered sleeve pack assembly. The assembly includes a cart having rigid side structures for supporting a plurality of alternating sleeves and dividers. The sleeves have an opening on one side allowing access to products on the dividers. The car can include a plurality of wheels extending from a base portion. The assembly can also include a base tray and a top cap.

### CROSS-REFERENCE TO RELATED APPLICATIONS

This application claims priority from and the benefit of U.S. Provisional Application No. 62/873,437 filed Jul. 12, 2019, the contents of which are incorporated herein by reference and made a part hereof.

### FEDERALLY SPONSORED RESEARCH OR DEVELOPMENT

N/A

### FIELD OF THE INVENTION

The present invention is generally directed to an assembly having multiple tiers of products that can be easily transported from one location to another, and more particularly, to an assembly having a plurality of sleeves having an opening on one side separated by dividers supported on a cart having rigid side structures.

### DESCRIPTION OF THE PRIOR ART

A number of different transport systems or assemblies utilize sleeves that can be easily folded when not in use. Such sleeves reduce the weight of the assemblies and allow for a greatly reduced volume when folded for return transport.

However, some of these sleeve based systems are too large for the retail supply chain and cannot be transported within a store. Instead, such systems have to be unloaded elsewhere and the product being transported must be relocated to within the store.

Additionally, some sleeve systems (even if small enough for transport into a store) require the system to be dismantled in order to remove product. In other systems that allow access to the product, the system is typically unstable and subject to sway or collapse during transport.

The present invention provides a stable system that can be readily moved within a store and allows easy access to the product being transported.

### SUMMARY OF THE INVENTION

The present invention is directed to a multi-tiered sleeve pack assembly having a cart with rigid side support structures. The assembly includes a base tray, alternating sleeves having an opening and dividers, and a top cap. The cart includes wheels and can easily be transported.

In accordance with one aspect of the invention, a multi-tiered sleeve pack assembly is provided. The assembly comprises a cart having a base portion and rigid side structures, such as posts extending upward from a base portion of the cart. A base tray is supported on the base portion of the cart. A plurality of sleeves and a plurality of dividers are supported on the base tray. The sleeves and dividers alternate from the base tray. The assembly can also include a top cap on a top sleeve of the plurality of sleeves. Alternatively, another divider can act as a top cap.

The sleeves include a first side panel, a back panel connected to the first side panel and a second side panel connected to the back panel. The sleeves have an opening in a front portion providing access to product loaded on the assembly.

The cart can be supported by four wheels. This allows the cart to be easily transported from location to location.

The rigid side structures can comprise a first post extending upward from the base portion on a first side of the base portion, and a second post extending upward from the base portion on a second side of the base portion. A third post can extend upward from the base portion and a fourth post can extend upward from the base portion. Cross beams connecting the posts or other similar structure can be added.

The plurality of sleeves and the plurality of dividers can be formed from plastic. One or more of these components can also be formed out of other suitable materials.

Each of the dividers can include a top surface and side walls extending upward about a periphery of the top surface. A channel can be formed proximate the upwardly extending side walls for receiving a bottom portion of the panels of one of the plurality of sleeves. Similarly, each divider can include a bottom surface and side walls extending downward about a periphery of the bottom surface. The divider can include a channel proximate the downwardly extending side walls for receiving a top portion of the panels of one of the plurality of sleeves.

Additionally, each divider can comprise an internal channel between the top surface and the bottom surface. A reinforcement member can be positioned in the internal channel. The reinforcement member can be a steel tube or some other similar or suitable materials or structures.

In accordance with one aspect of the invention, the top surface and the bottom surface of the divider can be horizontal. In accordance with another aspect of the invention, the top surface and the bottom surface of the divider are higher at the front of the divider and lower at the back of the divider. This causes the top surface to slope downward toward the back of the divider.

In accordance with another aspect of the invention, another multi-tiered sleeve pack assembly is provided. The assembly comprises a cart having a base portion and rigid side structures. Additionally, the assembly comprises a plurality of sleeves and a plurality of dividers supported on the cart wherein the sleeves and dividers alternate in an erected configuration and the sleeves have an opening on one side for allowing access to products.

The assembly further includes a base tray on the cart. Alternatively, the assembly can include a support component for supporting a bottom divider on the cart instead of a base tray. The support component can include a first strip of material, a second strip of material and a third strip of material. The first, second and third strips of material are configured to fit within a channel in a bottom surface of a divider.

The sleeves can include a first side panel, a back panel connected to the first side panel and a second side panel connected to the back panel. The opening in the sleeve is formed in a front of the assembly.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a set up and collapsed pallet with a sleeve and top cap in accordance with a known system;

FIG. 2 is a perspective view of a system having sleeves and dividers on a pallet in accordance with another known system;

FIG. 3 is a perspective view of a system having sleeves and dividers on a pallet in accordance with another known system;

FIG. 4 is a perspective view of a multi-tiered sleeve pack assembly in accordance with the present invention;

FIG. 5 is a perspective exploded view of the sleeves, dividers, base and top cap of the assembly of FIG. 4;

FIG. 6 is a perspective view of the assembly of FIG. 4 with the sleeves, dividers, base and top cap in a collapsed configuration;

FIG. 7 is a perspective cross-sectional view of a divider in accordance with an aspect of the present invention;

FIG. 8 is a perspective view of a multi-tiered sleeve pack assembly in accordance with another aspect of the present invention;

FIG. 9 is a cross-sectional view of a base tray with a sloped top surface in accordance with another aspect of the present invention; and,

FIG. 10 is a cross-sectional view of a divider with a sloped top and bottom surface in accordance with another aspect of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

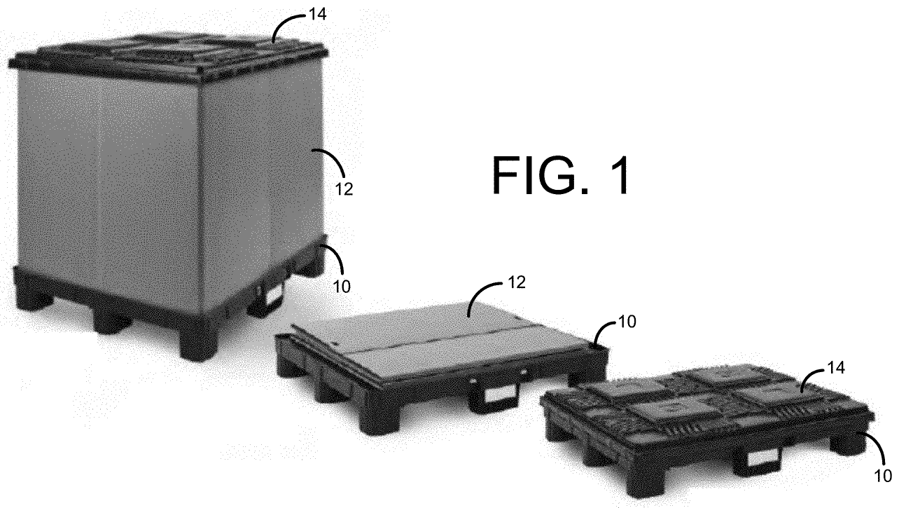

There are a number of systems that are used to transport products from one location to another. FIG. 1 shows one known system comprising a pallet 10, a sleeve 12 and a top cap 14. The system is shown in an erected configuration on the left side, a collapsed sleeve 12 and pallet 10 in the middle, and the top cap 14 and pallet 10 (with the sleeve—not visible—between them). This system is typically very large and is known to work well for transporting bulk items and its ability to collapse to a small size when empty provides great value for return hauls. However, to gain access to any products being transported, it is necessary to remove the top cap and sleeve. Additionally, the system is too large to fit through doorways and does not work for stocking operations in the retail supply chain.

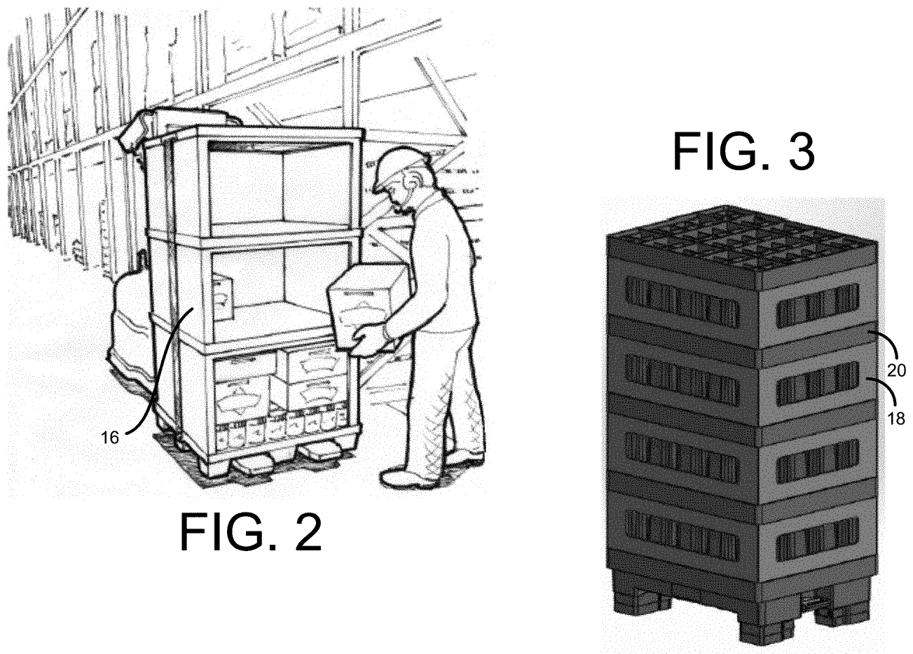

Two other known systems are shown in FIGS. 2 and 3. These systems are smaller than the system shown in FIG. 1 and can be more easily used for stocking at a retail location. The system shown in FIG. 2 has open (i.e., three sided) sleeves 16 that allow easy access to the products. However, the open sleeve 16 has issues with stability and has more sway during transport than a four side sleeve. The system of FIG. 3 has four side sleeves 18 separated by dividers 20, but requires removal of the sleeves 16 and dividers to obtain access to the products. This can be inconvenient if access is needed to the first or a lower tier before the upper tiers are emptied. The present invention overcomes the issues raised by the known systems.

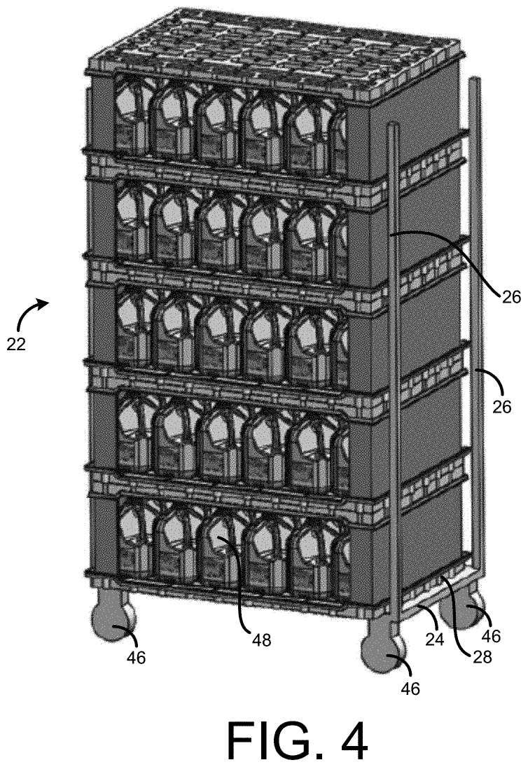

A preferred example of the multi-tiered sleeve pack assembly 22 is shown in FIG. 4. The assembly 22 includes a cart 24 having rigid side structures 26. The cart 24 supports a base tray 28 and a plurality of sleeves 30 and dividers 32 alternating from the base tray 28. A top cap 34 is positioned on the top sleeve 30.

The sleeves 30 are shown having a first side panel 36, a back panel 38 connected on one side to the first side panel 36, and a second side panel 40 connected to a second side of the back panel 38. The front of the sleeve 30 includes an opening 42, allowing access to products 48 supported on the base tray 28 or dividers 32. The sleeves 30 can also include short panels 44 that extend slightly from the side panels 36, 40 into the opening 42. The rigid side structures 26 of the cart 24 provide the support lost by the open sided sleeve 30, allowing for more secure transport.

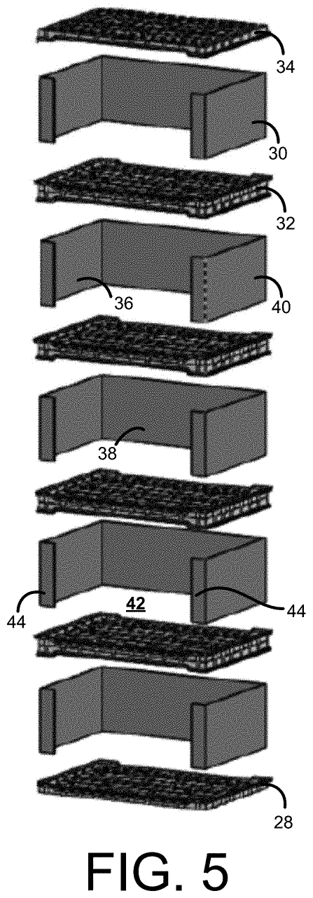

FIG. 5 provides an exploded view of the base tray 28, sleeves 30, dividers 32 and top cap 34 in an erected configuration (such as that shown in FIG. 5 on the cart 24). As evident, the sleeves 30 and dividers 32 alternate from the base tray 28.

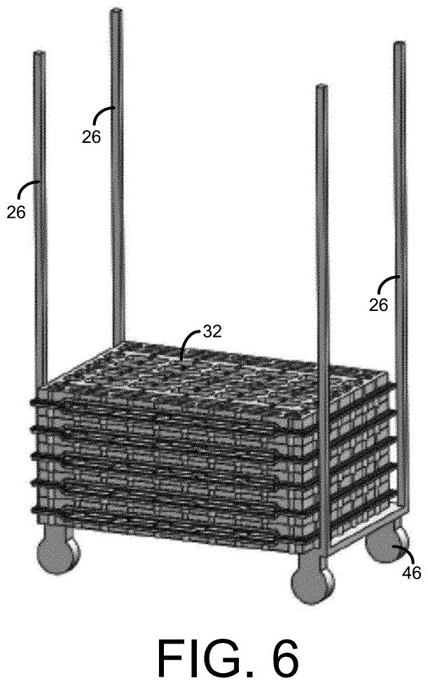

FIG. 6 shows the cart 24 with the base tray 28, sleeves 30, dividers 32 and top cap 34 in a collapsed configuration with the sleeves 30 folded and positioned between the base tray 28 and/or the dividers 32. The rigid side wall structures 26 are shown as posts extending upward from a base portion of the cart. In some instances the side wall structures 26 can be removable and/or expandable and collapsible to further reduce the volume of the cart when empty.

In both FIGS. 4 and 6, the cart 24 is shown having four wheels 46 extending downward from a bottom portion of the cart 24. This allows the cart 24 to be easily moved from one location to another.

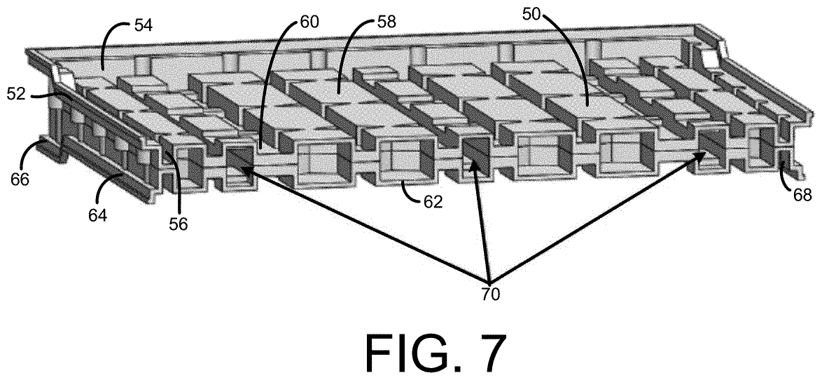

Additional features of the dividers 32 are shown in the cross-section of FIG. 7. Each divider 32 has a generally rectangular shape. The divider 32 includes an upper portion having an upper surface 50, and side walls 52, 54 extending upward around a periphery of the upper surface 50. The divider 32 also includes a channel 56 for receiving the bottom edges of the panels 36, 38, 40 and 44 of a sleeve 30. The channel 56 extends proximate or abutting the side walls 52, 54. In one configuration, the channel 56 can be broken into sections and the panels of the sleeves 32 can have corresponding tabs extending downward for placement in the channel sections. Other structures for securing the panels (e.g., upwardly extending clips) can also be used. The tray 28 can have features similar or identical to the upper portion of the divider 32.

The upper surface 50 has a generally convoluted structure with a plurality of upper support surfaces 58 that are generally in a plane separated by channels 60. This structure adds strength to the divider 32 and provides areas for draining any liquid spilled from products on the divider (e.g., when the system is transporting, for example, filled milk containers).

The dividers 32 also include a lower portion having a lower surface 62 and side walls 64, 66 extending downward around a periphery of the lower surface 60. The lower portion also includes a channel 68 proximate or abutting the side walls 64, 66 for receiving a top portion of the panels of a lower sleeve 30. In the example of FIG. 7, the lower portion of the dividers 32 is identical to the upper portion. This allows for either side of the divider 32 to be placed on a lower sleeve 30 and be able to support an upper sleeve 30.

The divider 32 of FIG. 7 also includes one or more internal channels 70 between the upper surface 50 and lower surface 62. Reinforcement members, such as steel bars or tubes (not shown) or other suitable materials or structures, can be inserted into the channels 70 for additional strength and support.

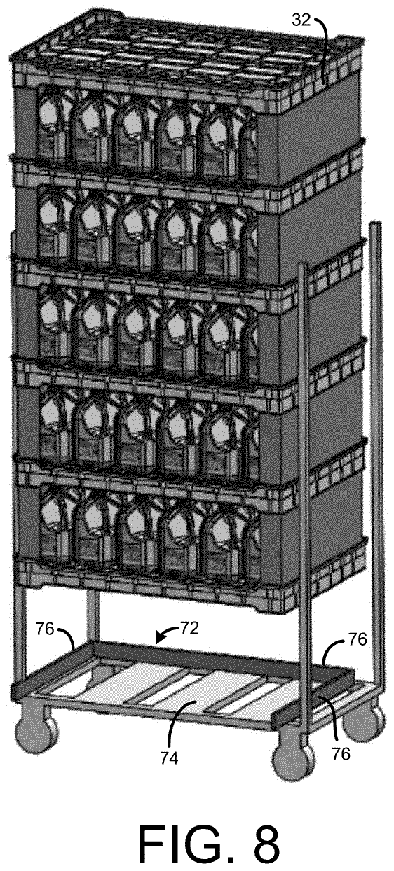

FIG. 8 shows a cart 24 with a support component 72 on the base 74 of the cart 24 which allows the lowest divider to be used instead of a base tray 28. The support component 72 includes three panels 76 configured to fit within the channel 68 of a divider 32 (the dividers 32, sleeves 30 and products 48 are shown spaced above the support component 72 for illustrative purposes to enable a clear view of the support component 72 and would be directly supported by the support component 72 in practice). The support component 72 can be made from the same material as the sleeves (e.g., extruded plastic), metal or other rigid material. The panels 76 of the support component 72 can be folded in a similar manner as the sleeves 30. As shown, the panels 76 of the support component 72 are not as high as the panels of the sleeves 30. A divider 32 is acting as a top cap 34 in this embodiment.

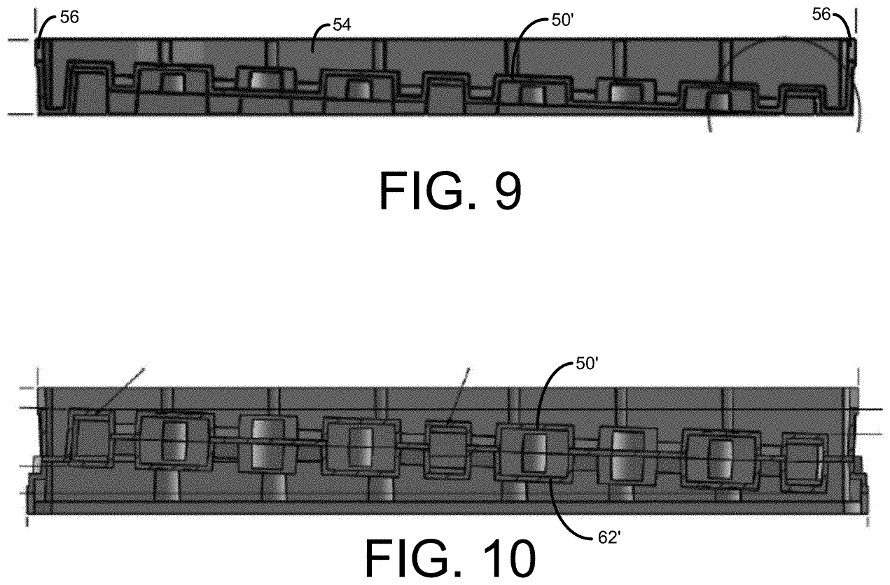

FIGS. 9 and 10 provide an alternative tray 28 and divider 32. In FIG. 9, the tray 28 (having features similar or identical to the upper portion of a divider 32) is shown in cross-section where the left side is the front (i.e., where the opening 42 of the sleeve 30 is positioned) and the right side is the back of the tray 32. In this version of the tray 28, the upper surface 50′ is shown sloping downwards from the front of the tray 28 to the back. The slope directs products towards the back wall of the system away from the opening 42 in the front. This may allow for removal of other containment features, such as the front side wall 56 or perimeter lip.

FIG. 10 shows a divider 32 with both the upper surface 50′ and lower surface 62′ sloping from a higher front position to a lower back position. Similar to the base tray 28, this directs products back towards the back side wall 56 of the divider 32.

Directional terms (e.g., top, bottom, upward, etc.) are used herein to describe the invention as typically used or as shown in the Figures, and are not meant to limit the scope of the claims.

In accordance with another embodiment, a multi-tiered system can be assembled with a dolly (a platform having wheels) and a plurality of sleeves and dividers, without having a rigid side structure. However, in this embodiment the sleeves and dividers would need to include four sides similar to the sleeves 18 and dividers 20 of FIG. 3 (i.e., the concept of FIG. 3, except on a dolly with wheels instead of a pallet).

Many modifications and variations of the present invention are possible in light of the above teachings. It is, therefore, to be understood within the scope of the appended claims the invention may be protected otherwise than as specifically described.

I claim:

1. A multi-tiered sleeve pack assembly comprising:
a cart having a base portion and rigid side structures;
a base tray on the cart; and
a plurality of sleeves and a plurality of dividers supported on the base tray wherein the sleeves and dividers alternate.

2. The assembly of claim 1 further comprising a top cap on a top sleeve of the plurality of sleeves.

3. The assembly of claim 1 wherein each of the sleeves includes a first side panel, a back panel connected to the first side panel, a second side panel connected to the back panel and an open front.

4. The assembly of claim 1 wherein the cart is supported by four wheels.

5. The assembly of claim 1 wherein the rigid side structures comprise a first post extending upward from the base portion on a first side of the base portion, and a second post extending upward from the base portion on a second side of the base portion.

6. The assembly of claim 5 further comprising a third post extending upward from the base portion and a fourth post extending upward from the base portion.

7. The assembly of claim 1 wherein the plurality of sleeves and the plurality of dividers are formed from plastic.

8. The assembly of claim 3 wherein each divider includes a top surface and side walls extending upward about a periphery of the top surface, and a channel proximate the upwardly extending side walls for receiving a bottom portion of the panels of one of the plurality of sleeves.

9. The assembly of claim 8 wherein each divider includes a bottom surface and side walls extending downward about a periphery of the bottom surface, and a channel proximate the downwardly extending side walls for receiving a top portion of the panels of one of the plurality of sleeves.

10. The assembly of claim 9 wherein each divider comprises a channel between the top surface and the bottom surface.

11. The assembly of claim 10 wherein each divider comprises a reinforcement member in the channel.

12. The assembly of claim 11 wherein the reinforcement member is a steel tube.

13. The assembly of claim 8 wherein the top surface of the divider is sloped toward a back portion of the divider.

14. The assembly of claim 1 wherein the base tray includes a top surface that is sloped downward toward a back portion of the base tray.

15. A multi-tiered sleeve pack assembly comprising:
a cart having a base portion and rigid side structures;
a plurality of sleeves and a plurality of dividers supported on the cart wherein the sleeves and dividers alternate in an erected configuration and the sleeves include an opening.

16. The assembly of claim 15 further comprising a base tray on the cart.

17. The assembly of claim 15 further comprising a support component for supporting a bottom divider on the cart.

18. The assembly of claim 17 wherein the support component has a first strip of material, a second strip of material and a third strip of material, the first, second and third strips of material configured to fit within a channel in a bottom surface of a divider.

19. The assembly of claim 15 further comprising a top cap.

20. The assembly of claim 15 wherein the sleeves include a first side panel, a back panel connected to the first side panel, a second side panel connected to the back panel and the opening is in a front of the assembly.
